(19) United States
(12) Patent Application Publication
(10) Pub. No.: US 2025/0176581 A1
(43) Pub. Date: Jun. 5, 2025

(54) A VEGETABLE FAT COMPOSITION FOR A CONFECTIONARY SPREAD

(71) Applicant: AAK AB (PUBL), Malmö (SE)

(72) Inventors: Hannah Solati SIMONSEN, Aarhus (DK); Karsten NIELSEN, Aarhus C (DK)

(21) Appl. No.: 18/727,534

(22) PCT Filed: Jan. 17, 2023
(86) PCT No.: PCT/SE2023/050042

§ 371 Date: Jul. 9, 2024

(30) Foreign Application Priority Data
Jan. 21, 2022 (SE) 2250054-0

(51) Int. Cl. A23G 1/36; A23D 7/00; A23D 7/005; A23D 7/01; A23G 1/48; A23G 1/56

(52) U.S. Cl. CPC A23G 1/36; A23D 7/001; A23D 7/0056; A23D 7/013; A23G 1/48; A23G 1/56

(57) ABSTRACT

The present invention relates to a vegetable fat composition for a confectionary spread, wherein the vegetable fat composition comprises a vegetable fat blend being an interesterified composition of at least a first vegetable fat component and a second vegetable fat component, the first vegetable fat component is selected from a liquid vegetable oil and the second vegetable fat component is shea olein.

### TECHNICAL FIELD

The present invention relates to a vegetable fat composition for a confectionary spread, wherein the vegetable fat composition comprises a vegetable fat blend being an interesterified composition of at least a first vegetable fat component and a second vegetable fat component, the first vegetable fat component is selected from a liquid vegetable oil and the second vegetable fat component is shea olein.

### BACKGROUND ART

Chocolate spreads (such as confectionary spreads) have long been enjoyed on bread, toast and pancakes. Originally promoted as sweet, chocolate-flavoured pastes for kids, they have become an essential item at breakfast and in all-day snacks in many markets.

Consumers are increasingly aware of the nutritional benefits of nuts. It is a significant factor supplementing the market growth of sweet spreads. New flavours, textures and formats are taking spreads beyond the traditional chocolate and hazelnut formulas. Consumers are open to new ways and times to enjoy spreads, especially as snacks. They are looking for exciting, new experiences from high-quality products. To meet that demand, spreads must deliver a delicious taste and texture.

Spreads therefore needs to be adapted to the consumers' preferences and with an appealing appearance to enhance all senses. There is therefore many things to consider when making a high-quality spread. One of the most important is the choice of oils and fats for the spread, as it influences properties such as taste, consistency, structure, and stability.

One problem however, with confectionary spreads of today is that upon storage at fridge temperatures, i.e. at or below 10° C., they become hard and not instantly spreadable. Another problem is that they are prone to oil separation at temperatures at or above room temperature (20° C.).

Accordingly, the main object of the invention is to provide oils and fats for use in making the spread, where the oils and fats will help in improving the spreadability of a confectionary spread at low temperatures (at or below 10° C.), while still maintaining stability characteristic towards oil separation at higher temperatures (at or above 20° C.).

### SUMMARY OF THE INVENTION

The present invention relates to a vegetable fat composition for a confectionary spread, wherein the vegetable fat composition comprises at least 40% by weight of a vegetable fat blend; wherein the vegetable fat blend is an interesterified composition of at least a first vegetable fat component and a second vegetable fat component, wherein the first vegetable fat component is selected from a liquid vegetable oil and the second vegetable fat component is shea olein, and wherein the first vegetable fat component is in a concentration from 5% to 65% by weight and the second vegetable fat component is in a concentration from 15% to 95% by weight.

For a spread to be able to be spreadable at fridge temperature ranges, it should contain reasonable amount of liquid oil. However, high levels of liquid oil in spreads makes them unstable at higher temperatures, i.e. at or above 20° C., and in addition thereto said spread go through oil separation upon storage. Therefore, a chocolate spread must contain sufficient liquid fat at refrigerator temperature in order to be a soft solid spreadable chocolate, while at the same time at ambient temperature, the spread must still comprise sufficient solid fat to prevent the spread from becoming pourable and oiling out.

The present invention solves this problem by providing a vegetable fat composition, which comprises at least 40% by weight of a vegetable fat blend, where the vegetable fat blend is an interesterified composition of a liquid vegetable oil and shea olein. This means that the present invention provides a vegetable fat composition, which is suitable for use in a confectionary spread giving excellent spreadability at low temperatures (at or below 10° C.) and the low degree of oil separation at temperatures at or above room temperature (20° C.).

It was found that the use of interesterification of a liquid vegetable oil together with a shea olein in the correct ratios to each other, created the triglyceride composition, which when used in a spread, maintained the spreadability at low temperatures, while avoiding the spread from becoming pourable and oiling out at higher temperatures, as shown in the examples.

The present invention therefore also relates to the use of a vegetable fat composition as disclosed herein in a confectionary spread and/or a confectionary filling, and a confectionary filling and a confectionary spread, both comprising a vegetable fat composition as disclosed herein.

Further, the present invention also relates to a confectionary spread comprising: one or more ingredients selected from cocoa butter, cocoa mass and/or cocoa powder; one or more ingredients selected from hazelnut paste, milk fat, milk powder, vanilla and/or lecithin; from 30% to 50% by weight of sugar; and from 1% to 40% by weight of a vegetable fat composition as disclosed herein.

### Definitions

In the context of the present invention, the following terms are meant to comprise the following, unless defined elsewhere in the description.

As used herein, the singular forms “a”, “an” and “the” include plural referents unless the context clearly dictates otherwise.

The terms “about”, “around”, or “approximately” are meant to indicate e.g. the measuring uncertainty commonly experienced in the art, which can be in the order of magnitude of e.g. +/−1, 2, 5, 10%, etc.

As used herein, the term “and/or” is intended to mean the combined (“and”) and the exclusive (“or”) use, i.e. “A and/or B” is intended to mean “A alone, or B alone, or A and B together”. For example in the context “the first vegetable fat component and/or the vegetable fat oil blend” it is thus intended to mean “the first vegetable fat component”, “the vegetable fat oil blend”, or “the first vegetable fat component and the vegetable fat oil blend”.

In here chocolate spread is chocolate-flavoured paste, which could be spread on breads and toasts or similar grain items such as waffles, pancakes, muffins, etc. It tastes, smells, and looks like chocolate, but is does not solidify at room temperature. It may comprise cocoa, vegetable fat components, milk or milk fat, sugar, nuts (e.g., ground hazelnuts or nut paste), honey, and additional flavours.

The term “comprising” or “to comprise” is to be interpreted as specifying the presence of the stated parts, steps, features, or components, but does not exclude the presence of one or more additional parts, steps, features, or components.

By using the nomenclature CX means that the fatty acid comprises X carbon atoms, e.g. a C16 fatty acid has 16 carbon atoms while a C18 fatty acid has 18 carbon atoms and C15 fatty acids has 14 carbon atoms.

By using the nomenclature CX: Y means that the fatty acid comprises X carbon atoms and Y double bonds, e.g. a C16:0 fatty acid has 16 carbon atoms and 0 double bonds while a C18:1 fatty acid has 18 carbon atoms and 1 double bond.

As used herein, the term “fatty acid” encompasses free fatty acids and fatty acid residues in triglycerides.

As used herein, “interesterification” should be understood as replacing one or more of the fatty acid moieties of a triglyceride with another fatty acid moiety or exchanging one or more fatty acid moieties from one triglyceride molecule to another. A fatty acid moiety may be understood as a free fatty acid, a fatty acid ester, a fatty acid anhydride, an activated fatty acid and/or the fatty acyl part of a fatty acid. The term “transesterification” as used herein may be used interchangeably with “interesterification”. The interesterification process may be an enzymatic interesterification or chemical interesterification. Both chemical interesterification and enzymatic interesterification is described well in the art. Both chemical and enzymatic interesterification may be done by standard procedures.

P means palmitic acid (C16:0). St means stearic acid (C18:0). O means oleic acid (C18:1). Li means linoleic acid (C18:2). Le means linolenic acid (C18:3).

Sat means a saturated fatty acid, and U means an unsaturated fatty acid. The fatty acids, which are comprised in the triglycerides of formulae Sat2U, SatUSat, etc., may be identical, or different, saturated and unsaturated fatty acids.

For saturated fatty acids, the abbreviation SAFA is used. Saturated fatty acids (Sat) are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated acid can exist in two forms, the cis form and the trans form. A double bond may exhibit one of two possible configurations: trans or cis. In trans configuration (a trans unsaturated fatty acid), the carbon chain extends from opposite sides of the double bond, whereas, in cis configuration (a cis unsaturated fatty acid), the carbon chain extends from the same side of the double bond. The trans unsaturated fatty acid is a straighter molecule. The cis unsaturated fatty acid is a bent molecule.

In all embodiments, the sum of polyunsaturated fatty acid (i.e. fatty acids having at least two or more double bounds) does not include trans unsaturated fatty acids, but only cis unsaturated fatty acids.

By OSatO is meant a symmetrical di-unsaturated triglyceride in which an unsaturated fatty acid (here oleic acid) occupies the sn1 and sn3 positions, and a saturated fatty acid (here unspecified) occupies the sn2 position.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

### Sn1/sn2/sn3:

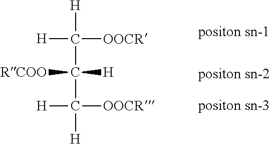

Fischer projection of a natural L-glycerol derivative.

As used herein, the term “triglycerides” may be used interchangeably with the term “triacylglycerides” and should be understood as an ester derived from glycerol and three fatty acids. “Triglycerides” may be abbreviated TG or TAG.

The % amount of a triglyceride (TAG) is determined using the AOCS Ce 5b-89 method which is a standard method for determining triglycerides in vegetable oils by HPLC. This method does not distinguish the different positional isomers of a given TAG, thus e.g. PPO and POP are measured as one.

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant or single cell organism origin.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

When using the terms “vegetable oil” and “vegetable fat” no weight should be put on the chemical or physical properties of an oil versus a fat.

As used herein, “% by weight” relates to weight percentage i.e. wt %, wt. % or wt.-%. E.g. by the sum of saturated fatty acids (SAFA) in the vegetable fat blend being 35% or less by weight is meant that no more than 35 wt % of the total weight of the fatty acids in the fat composition is from saturated fatty acids and by from 18% to 35% by weight is selected from OSatO, SatOO, or combinations thereof is meant between 18 and 35 wt % of the total weight of the triglycerides in the fat composition is from OSatO, SatOO, or combinations thereof. The given weight amounts in the fat composition is calculated from a composition containing approximately 100% triglycerides, however compositions containing up to 10 wt % minor components like free fatty acids, mono- and/or diglycerides may also be included.

By the term “liquid vegetable oil” is meant a vegetable oil/fat which has the consistency of a liquid, i.e. fluid/capable of flowing at room temperature (20° C.).

By the property “spreadable” is meant the ease with which a product can be spread. It is a common desired property of butter, margarines, jams and chocolate spreads. Spreadable is also sometimes referred to a “spoonable” or “spoonability”.

By the property “stable towards oil separation” is meant no separation of oil (oiling out/de-oiling/oil exudation) from the product is observed within the shelf-life of product.

Sorbitan tristearate (STS) is a nonionic surfactant. It is variously used as a dispersing agent, emulsifier, and stabilizer, in food and in aerosol sprays. As a food additive, it has the E number E492. The consistency of sorbitan tristearate is waxy; its color is light cream to tan.

### DETAILED DESCRIPTION OF THE INVENTION

The present invention relates to a vegetable fat composition for a confectionary spread, wherein the vegetable fat composition comprises at least 40% by weight of a vegetable fat blend; wherein the vegetable fat blend is an interesterified composition of at least a first vegetable fat component and a second vegetable fat component, wherein the first vegetable fat component is selected from a liquid vegetable oil and the second vegetable fat component is shea olein, and wherein the first vegetable fat component is in a concentration from 5% to 65% by weight and the second vegetable fat component is in a concentration from 15% to 95% by weight.

In one or more embodiments, the vegetable fat blend comprises triglycerides of which from 18% to 35% by weight is selected from OSatO, SatOO, or combinations thereof, wherein Sat is a saturated fatty acid selected from St (stearic acid), P (palmitic acid), or combinations thereof, and O is oleic acid (C18:1).

In one or more embodiments, the vegetable fat blend comprises triglycerides of which from 3% to 18% by weight is selected from SatOSat, SatSatO, or combinations thereof, wherein Sat is a saturated fatty acid selected from St (stearic acid), P (palmitic acid), or combinations thereof, and O is oleic acid (C18:1).

In one or more embodiments, the vegetable fat blend comprises triglycerides of which from 25% to 47% by weight is selected from UUU, wherein U is an unsaturated fatty acid selected from O (oleic acid), Li (linoleic acid), Le (linolenic acid), or combinations thereof.

In one or more embodiments, the vegetable fat blend comprises triglycerides of which 6% or less by weight is selected from SatSatSat, wherein Sat is a saturated fatty acid selected from St (stearic acid), P (palmitic acid), or combinations thereof.

In one or more embodiments, the sum of C16 fatty acids in the vegetable fat blend is from 3% to 6% by weight. The sum of C16 fatty acids is the total amount of all C16 fatty acids, including C16:0, C16:1, C16:2, C16:3, etc.

In one or more embodiments, the sum of C18 fatty acids in the vegetable fat blend is from 90% to 95% by weight. The sum of C18 fatty acids is the total amount of all C18 fatty acids, including

C18:0, C18:1, C18:2, C18:3, etc.

In one or more embodiments, the sum of saturated fatty acids (SAFA) in the vegetable fat blend is 35% or less by weight.

In one or more embodiments, the vegetable fat blend comprises triglycerides of which: from 18% to 35% by weight is selected from OSatO, SatOO, or combinations thereof, from 3% to 18% by weight is selected from SatOSat, SatSatO, or combinations thereof, from 25% to 47% by weight is selected from UUU, 6% or less by weight is selected from SatSatSat; and wherein, in the vegetable fat blend the: sum of C16 fatty acids is from 3% to 6% by weight, sum of C18 fatty acids is from 90% to 95% by weight, and sum of saturated fatty acids (SAFA) is 35% or less by weight; and wherein Sat is a saturated fatty acid selected from St (stearic acid), P (palmitic acid), or combinations thereof, and U is an unsaturated fatty acid selected from O (oleic acid), Li (linoleic acid), Le (linolenic acid), or combinations thereof.

In one or more embodiments, the vegetable fat blend comprises triglycerides of which from 25% to 35% by weight is selected from OSatO, SatOO, or combinations thereof, wherein Sat is a saturated fatty acid selected from St (stearic acid), P (palmitic acid), or combinations thereof, and O is oleic acid (C18:1).

In one or more embodiments, the vegetable fat blend comprises triglycerides of which from 12% to 18% by weight is selected from SatOSat, SatSatO, or combinations thereof, wherein Sat is a saturated fatty acid selected from St (stearic acid), P (palmitic acid), or combinations thereof, and O is oleic acid (C18:1).

In one or more embodiments, the vegetable fat blend comprises triglycerides of which from 25% to 35% by weight is selected from UUU, wherein U is an unsaturated fatty acid selected from O (oleic acid), Li (linoleic acid), Le (linolenic acid), or combinations thereof.

In one or more embodiments, the vegetable fat blend comprises triglycerides of which from 2% to 6% by weight is selected from SatSatSat, wherein Sat is a saturated fatty acid selected from St (stearic acid), P (palmitic acid), or combinations thereof.

In one or more embodiments, the sum of C16 fatty acids in the vegetable fat blend is from 3% to 5% by weight.

In one or more embodiments, the sum of C18 fatty acids in the vegetable fat blend is from 92% to 95% by weight.

In one or more embodiments, the sum of saturated fatty acids (SAFA) in the vegetable fat blend is from 28% to 34% or less by weight.

In one or more embodiments, the vegetable fat blend comprises triglycerides of which: from 25% to 35% by weight is selected from OSatO, SatOO, or combinations thereof, from 12% to 18% by weight is selected from SatOSat, SatSatO, or combinations thereof, from 25% to 35% by weight is selected from UUU, from 2% to 6% by weight is selected from SatSatSat; and wherein, in the vegetable fat blend the: sum of C16 fatty acids is from 3% to 5% by weight, sum of C18 fatty acids is from 92% to 95% by weight, and sum of saturated fatty acids (SAFA) is from 28 to 34% by weight; and wherein Sat is a saturated fatty acid selected from St (stearic acid), P (palmitic acid), or combinations thereof, and U is an unsaturated fatty acid selected from O (oleic acid), Li (linoleic acid), Le (linolenic acid), or combinations thereof.

In one or more embodiments, the vegetable fat blend is an interesterified composition of at least the first vegetable fat component, the second vegetable fat component, and a third vegetable fat component, wherein the third vegetable fat component is shea oil, and wherein the third vegetable fat component is in a concentration of 20% or less by weight.

This means that the interesterified composition may be a composition where at least three components, i.e. a liquid oil, a shea olein, and a shea oil has been interesterified with each other.

In one or more embodiments, the vegetable fat composition further comprises a vegetable fat oil blend, wherein the vegetable fat oil blend is in a concentration of 60% or less by weight, and wherein the vegetable fat oil blend is selected from one or more liquid vegetable oils.

This means that the vegetable fat composition can comprise up to 60% of a liquid oil in addition to the at least 40% of the interesterified vegetable fat blend.

In one or more embodiments, the first vegetable fat component is in a concentration from 20% to 55% by weight, such as in a concentration from 30% to 50% by weight.

In one or more embodiments, the second vegetable fat component is in a concentration from 30% to 80% by weight, such as in a concentration from 50% to 70% by weight.

In one or more embodiments, the first vegetable fat component is in a concentration from 5% to 10% by weight and the second vegetable fat component is in a concentration from 90% to 95% by weight.

In one or more embodiments, the vegetable fat composition further comprises sorbitan tristearate (STS), and wherein STS is in a concentration of 2% or less by weight, such as in a concentration of 1.5% or less by weight, such as in a concentration of 1% or less by weight, or such as in a concentration of 0.5% or less by weight.

In one or more embodiments, the vegetable fat blend comprises triglycerides of which 5% or less by weight is selected from SatSatSat, such as 4% or less by weight, such as 3% or less by weight, or such as 2% or less by weight.

It was found that more SatSatSat triglycerides will help with stabilization of a spread; however, the present disclosure is also able to have only a very small amount of SatSatSat (e.g. such as 1% SatSatSat). Such compositions were still stable towards oil separation due to an added amount of STS as disclosed herein. Therefore, the application of sorbitan tristearate (STS) is used to stabilize the spreads containing substantial amount of liquid oil, towards oil separation at temperatures above the ambient temperature, i.e. >20° C., if the SatSatSat amount in the final oil is very low.

In one or more embodiments, the sum of saturated fatty acids (SAFA) in the vegetable fat blend is 30% or less by weight, such as 25% or less by weight, or such as 20% or less by weight.

In one or more embodiments, the first vegetable fat component has a polyunsaturated fatty acid content of 35% or less by weight, such as 30% or less by weight, such as 25% or less by weight, such as 20% or less by weight, such as 15% or less by weight, or such as 10% or less by weight.

In one or more embodiments, the vegetable fat oil blend has a polyunsaturated fatty acid content of 35% or less by weight, such as 30% or less by weight, such as 25% or less by weight, such as 20% or less by weight, such as 15% or less by weight, or such as 10% or less by weight.

In one or more embodiments, the first vegetable fat component and/or the vegetable fat oil blend has a polyunsaturated fatty acid content of 35% or less by weight, such as 30% or less by weight, such as 25% or less by weight, such as 20% or less by weight, such as 15% or less by weight, or such as 10% or less by weight.

In one or more embodiments, the sum of oleic acid (C18:1) fatty acids in the vegetable fat blend is 50% or more by weight, such as 60% or more by weight, or such as 70% or more by weight.

In one or more embodiments, the sum of oleic acid (C18:1) fatty acids in the vegetable fat oil blend is 50% or more by weight, such as 60% or more by weight, or such as 70% or more by weight.

In one or more embodiments, the sum of oleic acid (C18:1) fatty acids in the vegetable fat blend and/or the vegetable fat oil blend is 50% or more by weight, such as 60% or more by weight, or such as 70% or more by weight.

In one or more embodiments, the first vegetable fat component is selected from rapeseed oil, sunflower oil, such as high oleic sunflower oil, olive oil, nut oil, such as almond nut oil or hazel nut oil, high olein cottonseed oil, high oleic safflower oil, soybean oil, high oleic grape seed oil, or combination thereof.

In one or more embodiments, the vegetable fat oil blend is selected from rapeseed oil, sunflower oil, such as high oleic sunflower oil, olive oil, nut oil, such as almond nut oil or hazel nut oil, high olein cottonseed oil, high oleic safflower oil, soybean oil, high oleic grape seed oil, or combination thereof.

In one or more embodiments, the first vegetable fat component and/or the vegetable fat oil blend is selected from rapeseed oil, sunflower oil, such as high oleic sunflower oil, olive oil, nut oil, such as almond nut oil or hazel nut oil, high olein cottonseed oil, high oleic safflower oil, soybean oil, high oleic grape seed oil, or combination thereof.

In one or more embodiments, the first vegetable fat component is selected from rapeseed oil, high oleic sunflower oil, or combination thereof.

In one or more embodiments, the first vegetable fat component is high oleic sunflower oil.

In one or more embodiments, the vegetable fat oil blend is selected from rapeseed oil, high oleic sunflower oil, or combination thereof.

In one or more embodiments, the vegetable fat oil blend is high oleic sunflower oil.

In one or more embodiments, the first vegetable fat component and/or the vegetable fat oil blend is selected from rapeseed oil, high oleic sunflower oil, or combination thereof.

Also disclosed herein is the use of a vegetable fat composition according to any of the embodiments as disclosed herein in a confectionary spread and/or a confectionary filling.

Further disclosed herein is a confectionary filling and a confectionary spread, both comprising a vegetable fat composition according to any of the embodiments as disclosed herein.

Even further disclosed is a confectionary spread comprising: one or more ingredients selected from cocoa butter, cocoa mass and/or cocoa powder; one or more ingredients selected from hazelnut paste, milk fat, milk powder, vanilla and/or lecithin; from 30% to 50% by weight of sugar; and from 1% to 40% by weight of a vegetable fat composition according to any of the embodiments as disclosed herein.

In one or more embodiments, the confectionary spread is spreadable at temperatures between 5° C. and 10° C.

In one or more embodiments, the confectionary spread is stable towards oil separation at temperatures at or above 20° C., such as temperatures at or above 25° C., or such as temperatures at or above 27° C., for at least 1 month, such as at least 2 months, or such as at least 3 months.

There are various ways of making a composition of the invention. Such ways are generally known to the skilled person. E.g. one way of making a composition according to the present invention could be via a process comprising the steps of:
a. providing a first vegetable fat component and mixing said first vegetable fat component with a second vegetable fat component in a reaction container hereby obtaining a vegetable fat blend, wherein the first vegetable fat component is in a concentration from 5% to 65% by weight and the second vegetable fat component is in a concentration from 15% to 95% by weight;
b. heating the vegetable fat blend under reduced pressure over a predefined period of time;
c. further increasing the temperature and heating the vegetable fat blend over a predefined period of time, and simultaneously lowering the pressure further compared to step b);
d. keeping the vegetable fat blend at the temperature and pressure of step c) for a predefined period of time;
e. optionally, removal of unwanted residue reactants from the resulting product of step d) by a distillation process;
f. optionally, bleaching, filtering, and/or deodorization of the resulting product of step d) or step e); thereby obtaining a vegetable fat blend;
g. optionally, mixing up to 40% by weight of the vegetable fat blend with up to 60% by weight of a vegetable fat oil blend;
thereby obtaining the vegetable fat composition.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The present invention is further illustrated by the following examples, which are not to be construed as limiting the scope of protection.

### EXAMPLES

### Example 1

Preparation of chemically interesterified fat blends.

The interesterified fat blends were prepared using a standard method within the art. After preparation of fat blends, the acid degree (° S) of the mixture is determined, and if the value is above 2, the mixture should be neutralized before heating the mixture to 125° C. for at least an hour under reduced pressure followed by cooling to the preferred temperature depending on the melting point of the mixture. After cooling the mixture, sodium methylate is added to the mixture and then the mixture is mixed under vacuum for approximately 1 to 3 hours, followed by a pH neutralising step. The mixture is dried under vacuum and then it is bleached using 2% bleaching soil and filtered to yield the final vegetable fat composition. The analytical results of the prepared interesterified fat blends are shown in Table 1.

TABLE 1

| | | | | | | | |
|---|---|---|---|---|---|---|---|
| | | | | | | | Fat H |
| Fat A | Fat B | Fat C | Fat D | Fat E | Fat F | Fat G | (Comp) |

Fat composition

| | | | | | | | | |
|---|---|---|---|---|---|---|---|---|
| *Interesterified | 100 | 100 | 100 | 100 | 100 | 50 | — | 100 |
| composition | | | | | | | | |
| (RX) | | | | | | | | |
| (% w/w) | | | | | | | | |
| Rape seed oil | — | — | — | — | — | 50 | — | — |
| (% w/w) | | | | | | | | |
| Fat F | — | — | — | — | — | — | 99.6 | — |
| (% w/w) | | | | | | | | |
| STS | — | — | — | — | — | — | 0.4 | — |
| (% w/w) | | | | | | | | |

*Interesterified composition (RX)

| | | | | | | | | |
|---|---|---|---|---|---|---|---|---|
| Shea olein | 95 | 85 | 70 | 50 | 55 | 95 | — | 100 |
| (% w/w) | | | | | | | | |
| Rape seed oil | 5 | 15 | 30 | 22 | 45 | 5 | — | — |
| (% w/w) | | | | | | | | |
| shea oil | — | — | — | 28 | — | — | — | — |
| (% w/w) | | | | | | | | |

Solid fat content (SFC)**

| | | | | | | | | |
|---|---|---|---|---|---|---|---|---|
| SFC 10° C. | 8.6 | 5.9 | 4.6 | 9.0 | 3.0 | 4.8 | 4.8 | 11.0 |
| SFC 20° C. | 5.3 | 4.0 | 2.5 | 6.1 | 2.0 | 2.4 | 2.4 | 8.7 |
| SFC 25° C. | 4.3 | 2.9 | 1.8 | 4.5 | 1.1 | 1.7 | 1.7 | 5.8 |
| SFC 30° C. | 2.8 | 2.1 | 1.0 | 3.1 | 0.6 | 1.2 | 1.2 | 4.1 |
| SFC 35° C. | 2.1 | 1.3 | 0.5 | 2.1 | <0.5 | <0.5 | <0.5 | 2.6 |
| SFC 40° C. | 0.6 | <0.5 | <0.5 | 0.8 | <0.5 | <0.5 | <0.5 | 1.4 |

Fatty acid composition***

| | | | | | | | | |
|---|---|---|---|---|---|---|---|---|
| C16:0 | 3.8 | 3.9 | 4.0 | 3.8 | 4.1 | 4.1 | 4.3 | 5.0 |
| (% w/w) | | | | | | | | |
| C18:0 | 26.3 | \|23.4 | 19.2 | 25.9 | 15.1 | 13.0 | 13.2 | 28.1 |
| (% w/w) | | | | | | | | |
| C18:1 cis | 57.2 | 58.0 | 59.3 | 55.2 | 60.3 | \|60.9 | 60.7 | 55.1 |
| (% w/w) | | | | | | | | |
| C18:2 cis | 9.3 | 10.4 | 12.0 | 10.4 | 13.5 | 14.3 | 14.2 | 8.9 |
| (% w/w) | | | | | | | | |
| C18:3 cis | 0.7 | 1.6 | 2.9 | 2.2 | 4.0 | 4.6 | 4.6 | 0.2 |
| (% w/w) | | | | | | | | |
| C20:0 | 1.1 | 1.1 | 1.0 | 1.1 | 0.9 | 0.8 | 0.8 | 1.2 |
| (% w/w) | | | | | | | | |
| SAFA | 31.4 | 28.7 | 24.5 | 31.1 | 20.3 | 18.2 | 18.6 | 34.5 |
| (% w/w) | | | | | | | | |
| Total trans | 0.6 | 0.5 | 0.3 | 0.3 | 0.6 | 0.6 | 0.6 | 0.7 |
| (% w/w) | | | | | | | | |

Triglyceride (TAG) composition****

| | | | | | | | | |
|---|---|---|---|---|---|---|---|---|
| LiLiLi | 0.4 | 0.8 | 0.0 | 1.0 | 2.6 | 4.3 | 4.4 | 0.0 |
| (% w/w) | | | | | | | | |
| PLeO | 0.7 | 1.8 | 3.7 | 2.2 | 5.4 | 0.8 | 0.9 | 0.0 |
| (% w/w) | | | | | | | | |
| StLeLi | 1.7 | 2.0 | 2.5 | 1.9 | 3.2 | 6.6 | 6.7 | 1.5 |
| (% w/w) | | | | | | | | |
| LiOO | 9.5 | 10.9 | 12.9 | 9.9 | 15.4 | 17.2 | 17.2 | 8.1 |
| (% w/w) | | | | | | | | |
| PLiO | 2.0 | 2.9 | 4.0 | 3.5 | 4.7 | 3.5 | 3.6 | 1.8 |
| (% w/w) | | | | | | | | |
| OOO | 20.0 | 20.6 | 21.4 | 17.5 | 22.5 | 25.3 | 26.1 | 17.1 |
| (% w/w) | | | | | | | | |
| StLiO | 8.9 | 8.9 | 9.1 | 9.4 | 8.1 | 4.7 | 5.0 | 9.0 |
| (% w/w) | | | | | | | | |
| POO | 4.1 | 4.3 | 4.8 | 3.8 | 4.8 | 4.6 | 4.9 | 4.7 |
| (% w/w) | | | | | | | | |
| StOO | 26.1 | 23.7 | 20.8 | 23.7 | 16.7 | 12.7 | 12.8 | 27.5 |
| (% w/w) | | | | | | | | |
| StLiSt | 1.7 | 1.5 | 1.3 | 2.2 | 0.0 | 0.0 | 0.7 | 2.4 |
| (% w/w) | | | | | | | | |
| POSt | 3.3 | 3.1 | 2.8 | 3.3 | 2.1 | 1.6 | 1.6 | 4.0 |
| (% w/w) | | | | | | | | |
| StOSt | 11.3 | 9.3 | 6.7 | 11.0 | 4.2 | 5.1 | 5.2 | 12.8 |
| (% w/w) | | | | | | | | |
| SatSatSat # | 4.3 | 3.3 | 2.6 | 3.5 | 1.9 | 2.2 | 0.8 | 3.7 |
| (% w/w) | | | | | | | | |

# SatSatSat triglycerides are the total amount of PPP, PPSt, PStSt, and StStSt triglycerides.
**The solid fat content (SFC) was measured according to IUPAC 2.150b.
***The fatty acid compositions of the vegetable fat compositions were analyzed using IUPAC 2.301 (Methylation) and IUPAC 2.304 (GLC).
****The % amount of a TAG is determined using the AOCS Ce 5b-89 method, which is a standard method for determining triglycerides in vegetable oils by HPLC.

### Example 2

### Preparation of the Confectionary Spreads:

Confectionary spreads were prepared according to the formulation disclosed in table 2. All ingredients mentioned in the recipe except lecithin and some of the fat are mixed using a Hobart N-50 mixer at 55° C. until a homogeneous and marzipan-like consistency is reached. Then the mixture is refined using a Bühler SDY-300 three-roll refiner (with 300 mm width) to a particle size of 20 microns #2 microns. The refined product is then added to the mixer bowl again and conched for 3 hours at 55° C. After conching for 21/2 hours the lecithin was added and after 2¾ hours the rest of the fat was added and conching continued. The spreads were pre-cooled at 35° C., deposited into small plastic cups and stored at 20° C. for 7 days before being moved to cabinets with different isothermal temperatures for further evaluations.

TABLE 2

| Ingredient | % w/w |
|---|---|
| Sugar (% w/w) | 48.08 |
| Fat A-H (% w/w)* | 22.00 |
| Hazelnut paste (% w/w) | 13.00 |
| Skim milk powder (% w/w) | 9.00 |
| Cocoa powder (10-12%) - | 7.50 |
| Alkalized (% w/w) | |
| Lecithin (% w/w) | 0.40 |
| Vanillin (% w/w) | 0.02 |

Fat composition

| | |
|---|---|
| Vegetable fat (% w/w) | 69.85 |
| Cocoa butter (% w/w) | 2.62 |
| Milk fat (% w/w) | 0.29 |
| Nut oil (% w/w) | 27.24 |
| Fat (% w/w) | 31.49 |

*Does not include hazelnut oil and cocoa butter. When using Fat G it corresponds to only 21.91% fat composition and 0.09% STS in the fat (equal to 22.00% - see table 1).

### Example 3

### Evaluation of Spreadability:

With the butter knife, a certain amount of product was taken and placed on a cardboard tray with an approximately 45° angle. In one smooth motion the knife was dragged across the cardboard tray and the ease of spreadability was rated. Spreadability measurement was performed both at 5° C. and 20° C. using a butter knife with an equivalent temperature. Spreadability was indicated using a scale from 1 to 5:
1. Spread is fluid and pourable.
2. Almost fluid, a long sticky tail when lifted with a knife.
3. Soft and easy to spread out.
4. Still possibly to spread out, but significantly harder than the above.
5. Too hard, not spreadable.

When spreadability was between two scales it is indicated with a dash (-). Evaluations were made by a trained test panel consisted of 8 persons and results shown are the average of the given characters by the test panel. The results can be seen in table 3.

TABLE 3

| | | | | | | | | |
|---|---|---|---|---|---|---|---|---|
| Confectionary | | | | | | | | H1 |
| spreads | A1 | B1 | C1 | D1 | E1 | F1 | G1 | (Comp) |

Spreadability at 5° C.

| | | | | | | | | |
|---|---|---|---|---|---|---|---|---|
| Manual | 5 | 5 | 4 | 5 | 3-4 | 3 | 3 | 5 |
| spreadability | | | | | | | | |
| (After 1 week | | | | | | | | |
| of storage) | | | | | | | | |
| Manual | 5 | 5 | 4-5 | 5 | 3-4 | 3 | 3 | 5 |
| spreadability | | | | | | | | |
| (1 month) | | | | | | | | |
| Manual | 5 | 5 | 4-5 | 5 | 3-4 | 3 | 3 | 5 |
| spreadability | | | | | | | | |
| (3 month) | | | | | | | | |

Spreadability at 20° C.

| | | | | | | | | |
|---|---|---|---|---|---|---|---|---|
| Manual | 2-3 | 2-3 | 2-3 | 3 | 2-3 | 1-2 | 2 | 3 |
| spreadability | | | | | | | | |
| (1 week) | | | | | | | | |
| Manual | 3 | 2-3 | 2-3 | 3 | 2 | 1-2 | 2 | 3 |
| spreadability | | | | | | | | |
| (1 month) | | | | | | | | |
| Manual | 3 | 2-3 | 2-3 | 3 | 2 | 1-2 | 2 | 3 |
| spreadability | | | | | | | | |
| (3 month) | | | | | | | | |

The results of table 3 shows that addition of liquid oil to shea olein prior to interesterification created a confectionary spread that was spreadable at 5° C. Even though it was possible to spread out confectionary spread C1 at 5° C., confectionary spreads E1, F1, and G1 were preferable with respect to ease of spreadability at 5° C. This means that higher amount of liquid oil is necessary for an easily spreadable confectionary spread at 5° C. However, there is a limit to the amount of liquid oil in the confectionary spread as it becomes too soft at ambient temperature i.e. 20° C. Considering this, confectionary spread E1 was the most preferred with desirable spreadability both at 5° C. and 20° C.

Further, the results also show that addition of 0.4% STS to fat composition F, hereby obtaining fat composition G, had a positive impact on spreadability of confectionary spread G1 compared to confectionary spread F1 at 20° C. without making the spread harder at 5° C. This means that confectionary spread G1 was less soft at 20° C. compared to confectionary spread F1.

### Example 4

### Evaluation of Oil Separation:

Confectionary spreads prepared according to example 2 were stored for at least 7 days at 20° C. before being moved to test cabinets with varying isothermal temperatures of 20° C., 25° C., and 27° C. for evaluation of oil separation. Measurements were performed after 1 week, 1 month, 2 months, and 3 months of storage at the aforementioned temperatures. Oil separation was evaluated visually by tipping the cup containing the confectionary spread. The amount of oil separated on top was monitored and characters −, +, ++, and +++ were assigned based on the amount of oil separated on surface of the confectionary spreads as described below:
−: No oil droplet on the surface of confectionary spread.
+: One drop of oil separated on the surface of confectionary spread.
++: More than one drop of oil separated on the surface of confectionary spread.
+++: Substantial amount of oil separated on the surface of confectionary spread.

Evaluations were made by a trained test panel consisted of 8 persons and results shown are the average of the given characters by the test panel (table 4).

TABLE 4

| | | | | | | | | |
|---|---|---|---|---|---|---|---|---|
| Confectionary | | | | | | | | H1 |
| spreads | A1 | B1 | C1 | D1 | E1 | F1 | G1 | (Comp) |

Oil separation 20° C.

| | | | | | | | | |
|---|---|---|---|---|---|---|---|---|
| 1 week | − | − | − | − | − | − | − | − |
| 1 month | − | − | − | − | − | − | − | − |
| 2 month | − | − | − | − | − | − | − | − |
| 3 month | − | − | − | − | − | − | − | − |

Oil separation 25° C.

| | | | | | | | | |
|---|---|---|---|---|---|---|---|---|
| 1 week | − | − | − | − | − | + | − | − |
| 1 month | − | − | − | − | − | + | − | − |
| 2 month | − | − | − | − | − | ++ | − | − |
| 3 month | − | − | − | − | − | ++ | − | − |

Oil separation 27° C.

| | | | | | | | | |
|---|---|---|---|---|---|---|---|---|
| 1 week | − | − | − | − | − | + | − | − |
| 1 month | − | − | − | − | + | + | − | − |
| 2 month | − | − | − | − | + | ++ | − | − |
| 3 month | − | − | + | − | + | ++ | + | − |

The results of table 4 shows that all confectionary spreads were stable towards oil separation at 20° C. for up to three months. However, confectionary spread F1 with substantial amount of liquid oil in its fat composition showed oil separation already after a week of storage at 25° C. It is in this regard shown that by adding 0.4% STS to fat F (i.e. a fat comprising a substantial amount of liquid oil), the resulting confectionary spread G1 was stabilized when stored at 25° C. towards oil separation for at least 3 months.

All confectionary spreads except for confectionary spread F1 were stable towards oil separation at 27° C. for more than 2 months. Confectionary spread F1 with substantial amount of liquid oil in its fat composition showed oil separation already after 1 week of storage at 27° C. Again, noteworthy is that addition of 0.4% STS to such fat composition with substantial amount of liquid oil (fat composition F), stabilized the confectionary spread stored at 27° C. towards oil separation for more than 2 months (confectionary spread G1).

Comparing confectionary spreads E1 and F1 both comprised of substantial amount of liquid oil in their fat compositions revealed that inclusion of substantial amount of liquid oil in the vegetable fat composition before interesterification (the case for fat composition E) as opposed to addition of substantial amount of liquid oil after interesterification (the case for fat composition F) resulted in confectionary spreads with significantly better stability towards oil separation at temperatures above 20° C.

### CONCLUSION

It is known from the art that a reasonable amount of liquid oil in a confectionary spread composition is necessary for spreadability at fridge temperatures i.e. temperatures at or below 10° C. However, such amount of liquid oil both makes the spread too soft at ambient temperature i.e. 20° C., and unstable towards oil separation at temperatures at or above 20° C. However, results of the present invention shows that using a moderate amount of liquid oil in the composition of confectionary spread can make it both spreadable at 5° C. with desirable spreadability at 20° C. and stable towards oil separation at temperatures at or above 20° C. for more than 2 months (e.g. confectionary spread C1 which is comprised of fat composition C of the invention). When substantial amount of liquid oil is used in the composition of confectionary spread, the stability of spread can be improved by addition of a small amount of STS (confectionary spread G1). Thus, STS can further improve stability of confectionary spreads comprising either moderate or substantial amount of liquid oil.

The results of the examples further indicated that addition of liquid oil to shea olein prior to interesterification and using such interesterification oil as a vegetable fat composition in a confectionary spread is suitable for producing confectionary spreads with better stability towards oil separation and better spreadability at 20° C. compared to addition of liquid oil after the interesterification.

1. A vegetable fat composition for a confectionary spread, wherein the vegetable fat composition comprises at least 40% by weight of a vegetable fat blend; wherein the vegetable fat blend is an interesterified composition of at least a first vegetable fat component and a second vegetable fat component, wherein the first vegetable fat component is selected from a liquid vegetable oil and the second vegetable fat component is shea olein, and wherein the first vegetable fat component is in a concentration from 5% to 65% by weight and the second vegetable fat component is in a concentration from 15% to 95% by weight.

2. The vegetable fat composition according to claim 1, wherein the vegetable fat blend comprises triglycerides of which:
from 18% to 35% by weight is selected from OSatO, SatOO, or combinations thereof,
from 3% to 18% by weight is selected from SatOSat, SatSatO, or combinations thereof,
from 25% to 47% by weight is selected from UUU, 6% or less by weight is selected from SatSatSat; and
wherein, in the vegetable fat blend the:
sum of C16 fatty acids is from 3% to 6% by weight,
sum of C18 fatty acids is from 90% to 95% by weight, and
sum of saturated fatty acids (SAFA) is 35% or less by weight; and
wherein Sat is a saturated fatty acid selected from St (stearic acid), P (palmitic acid), or combinations thereof, and U is an unsaturated fatty acid selected from O (oleic acid), Li (linoleic acid), Le (linolenic acid), or combinations thereof.

3. The vegetable fat composition according to claim 1, wherein the vegetable fat blend is an interesterified composition of at least the first vegetable fat component, the second vegetable fat component, and a third vegetable fat component, wherein the third vegetable fat component is shea oil, and wherein the third vegetable fat component is in a concentration of 20% or less by weight.

4. The vegetable fat composition according to claim 1, wherein the vegetable fat composition further comprises a vegetable fat oil blend, wherein the vegetable fat oil blend is in a concentration of 60% or less by weight, and wherein the vegetable fat oil blend is selected from one or more liquid vegetable oils.

5. The vegetable fat composition according to claim 1, wherein the vegetable fat composition further comprises sorbitan tristearate (STS), and wherein STS is in a concentration of 2% or less by weight.

6. The vegetable fat composition according to claim 1, wherein the vegetable fat blend comprises triglycerides of which 5% or less by weight is selected from SatSatSat.

7. The vegetable fat composition according to claim 1, wherein the first vegetable fat component and/or the vegetable fat oil blend has a polyunsaturated fatty acid content of 35% or less by weight.

8. The vegetable fat composition according to claim 1, wherein, in the vegetable fat blend and/or the vegetable fat oil blend, the sum of oleic acid (C18:1) fatty acids is 50% or more by weight.

9. The vegetable fat composition according to claim 1, wherein the first vegetable fat component and/or the vegetable fat oil blend is selected from rapeseed oil, sunflower oil, olive oil, nut oil, high olein cottonseed oil, high oleic safflower oil, soybean oil, high oleic grape seed oil, or any combination thereof.

10. The vegetable fat composition according to claim 1, wherein the first vegetable fat component and/or the vegetable fat oil blend is selected from rapeseed oil, high oleic sunflower oil, or any combination thereof.

11. A method of making a confectionary spread and/or a confectionary filling comprising addition of a vegetable fat composition according to claim 1.

12. A confectionary filling comprising a vegetable fat composition according to claim 1.

13. A confectionary spread comprising a vegetable fat composition according to claim 1.

14. A confectionary spread comprising:
one or more ingredients selected from cocoa butter, cocoa mass and/or cocoa powder;
one or more ingredients selected from hazelnut paste, milk fat, milk powder, vanilla and/or lecithin;
from 30% to 50% by weight of sugar; and
from 1% to 40% by weight of a vegetable fat composition according to claim 1.

15. The confectionary spread according to claim 14, wherein the confectionary spread is spreadable at temperatures between 5° C. and 10° C.

16. The confectionary spread according to claim 14, wherein the confectionary spread is stable towards oil separation at temperatures at or above 20° C., for at least 1 month.
